(19) United States
(12) Patent Application Publication
(10) Pub. No.: US 2023/0087755 A1
(43) Pub. Date: Mar. 23, 2023

(54) COMMUNICATION SYSTEM, TRANSMITTER, RECEIVER, AND COMMUNICATION METHOD AND PROGRAM

(71) Applicant: NIPPON TELEGRAPH AND TELEPHONE CORPORATION, Tokyo (JP)

(72) Inventors: Yuhei KAWAKAMI, Musashino-shi, Tokyo (JP); Takahiro KUBO, Musashino-shi, Tokyo (JP); Shinichi YOSHIHARA, Musashino-shi, Tokyo (JP); Natsuki YASUHARA, Musashino-shi, Tokyo (JP); Go YAZAWA, Musashino-shi, Tokyo (JP)

(73) Assignee: NIPPON TELEGRAPH AND TELEPHONE CORPORATION, Tokyo (JP)

(21) Appl. No.: 17/908,590

(22) PCT Filed: Mar. 2, 2020
(86) PCT No.: PCT/JP2020/008700

§ 371 Date: Sep. 1, 2022

(51) Int. Cl. H04L 45/24

(52) U.S. Cl. CPC H04L 45/24

(57) ABSTRACT

According to one embodiment, there is provided a communications system that conducts multiplex communications of main signals and at least one sub-signal via redundant routes between a transmission apparatus and a reception apparatus. The transmission apparatus includes a main signal duplication unit configured to duplicate each of the main signals to be communicated via a main signal channel, according to the number of the redundant routes, and a delay unit configured to adjust sending timings of copies of the main signal on the respective redundant routes based on the at least one sub-signal to be communicated via a sub-signal channel and transmit the copies of the main signal to the respective redundant routes. The reception apparatus includes a main signal selection unit configured to select one of the copies of the main signal communicated via the main signal channel, according to reception timings of the copies of the main signal passing through the respective redundant routes, and a sub-signal decoding unit configured to decode the at least one sub-signal communicated via the sub-signal channel based on which of the redundant routes the selected copy of the main signal has passed.

### TECHNICAL FIELD

An embodiment of the present invention relates to a communications system, a transmission apparatus, a reception apparatus, a communications method, and a program.

### BACKGROUND ART

In frame communications, there is a system that enables uninterruptible switching on redundant routes (see, for example, Patent Literature 1).

In the system, an uninterruptible apparatus on a sending end duplicates user data frames to be transmitted and transmits the frames to redundant routes including two relay routes, and an uninterruptible apparatus on a receiving end selectively receives frames using a selector. In a redundant section, a short route and a long route may switch from one to the other due to a delay, disconnection of one of the routes, or the like. Even in such a case, because frame order is managed by sequence numbers, as long as user data frames can be received successfully via any one of the relay routes among the redundant routes, communications can be continued in an uninterruptible manner. Because the same signal is transmitted to the two relay routes, there is no deterioration of data obtained on the receiving end regardless of which route has been passed by the user data frame selected by the selector on the receiving end.

### CITATION LIST

### Patent Literature

Patent Literature 1: Japanese Patent Laid-Open No. 2005-102157

### SUMMARY OF THE INVENTION

### Technical Problem

On the other hand, a multiplexing technique for multiplexing communications on a single route is known.

Generally, to multiplex communications, processes such as giving VLAN (Virtual Local Area Network) tags to user data frames are necessary. However, due to restrictions of a network or applications, there are cases in which frame format for multiplexing cannot be handled.

The present invention is intended to provide a technique that makes it possible to multiplex communications of main signals and communications of sub-signals without assigning identifiers to main signals of user data frames and the like on redundant routes.

### Means for Solving the Problem

To solve the above problem, according to one aspect of the present invention, there is provided a communications system that conducts multiplex communications of main signals and at least one sub-signal via redundant routes between a transmission apparatus and a reception apparatus wherein: the transmission apparatus includes: a main signal duplication unit configured to duplicate each of the main signals to be communicated via a main signal channel, according to the number of the redundant routes, and a delay unit configured to adjust sending timings of copies of the main signal on the respective redundant routes based on the at least one sub-signal to be communicated via a sub-signal channel and transmit the copies of the main signal to the respective redundant routes; and the reception apparatus includes: a main signal selection unit configured to select one of the copies of the main signal communicated via the main signal channel, according to reception timings of the copies of the main signal passing through the respective redundant routes, and a sub-signal decoding unit configured to decode the at least one sub-signal communicated via the sub-signal channel based on which of the redundant routes the selected copy of the main signal has passed.

### Effects of the Invention

The aspect of the present invention can provide a technique that makes it possible to multiplex communications of main signals and communications of sub-signals without assigning identifiers to main signals on a redundant route.

### BRIEF DESCRIPTION OF DRAWINGS

FIG. 1 is a block diagram showing an exemplary schematic configuration of a communications system according to a first embodiment of the present invention.

FIG. 2 is a block diagram showing an exemplary functional configuration of an uninterruptible apparatus.

FIG. 3 is a diagram showing an exemplary hardware configuration of the uninterruptible apparatus.

FIG. 4 is a flowchart showing an exemplary transmission processing operation of the uninterruptible apparatus.

FIG. 5 is a schematic diagram for explaining operation of the communications system.

FIG. 6 is a flowchart showing an exemplary reception processing operation of the uninterruptible apparatus.

FIG. 7 is a block diagram showing an exemplary configuration of an uninterruptible apparatus in a communications system according to a second embodiment of the present invention.

FIG. 8 is a block diagram showing an exemplary configuration of an uninterruptible apparatus in a communications system according to a third embodiment of the present invention.

FIG. 9 is a schematic diagram for explaining operation of a communications system according to a fourth embodiment of the present invention.

FIG. 10 is a schematic diagram showing an exemplary schematic configuration, and explaining operation, of a communications system according to a fifth embodiment of the present invention.

FIG. 11 is a block diagram showing an exemplary configuration of an uninterruptible apparatus in the communications system according to the fifth embodiment.

FIG. 12 is a schematic diagram showing an exemplary schematic configuration, and explaining operation, of a communications system according to a sixth embodiment of the present invention.

FIG. 13 is a block diagram showing an exemplary configuration of an uninterruptible apparatus in the communications system according to the sixth embodiment.

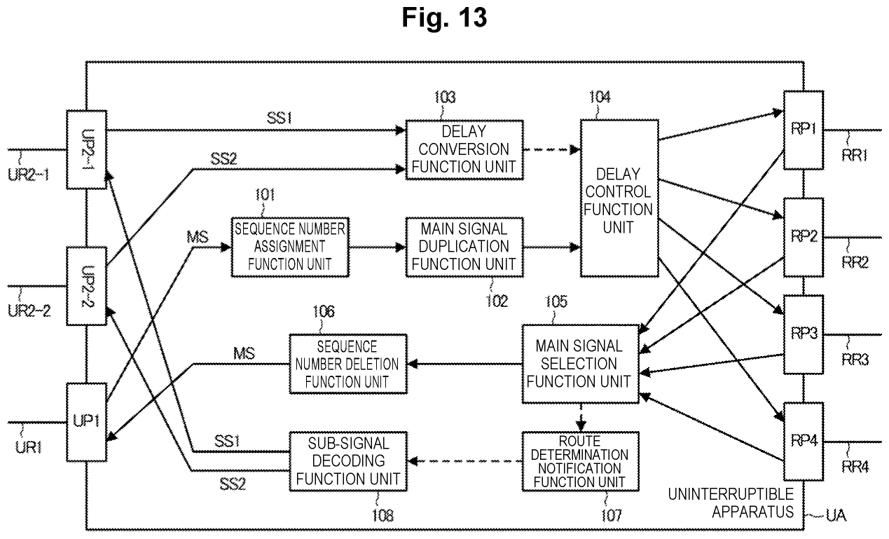

### DESCRIPTION OF EMBODIMENTS

Embodiments of the present invention will be described below with reference to the drawings.

### First Embodiment

A communications system conducts multiplex communications of signals between two uninterruptible apparatuses via redundant routes including plural relay routes. For the simplicity of drawings and explanation, description will be given below by taking as an example a case in which the number of relay routes is two, but the present invention is not limited to this.

(Configuration)

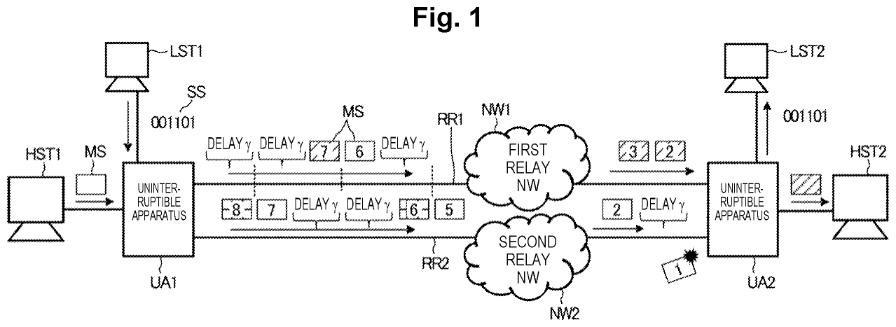

FIG. 1 is a block diagram showing an exemplary schematic configuration of a communications system according to a first embodiment of the present invention.

The communications system includes a first uninterruptible apparatus UA1 serving as a transmission apparatus, a second uninterruptible apparatus UA2 serving as a reception apparatus, and a first relay route RR1 and a second relay route RR2, which are two relay routes provided between the uninterruptible apparatuses. Hereinafter, the first uninterruptible apparatus UA1 and the second uninterruptible apparatus UA2 will be referred to as the uninterruptible apparatuses UA when there is no need to specifically distinguish between the two. Similarly, the two relay routes RR1 and RR2 will be referred to as the relay routes RR when there is no need to specifically distinguish between the two.

The first relay route RR1 is part of a first relay network NW1 (in FIG. 1, networks are abbreviated to NW), and the second relay route RR2 is part of a second relay network NW2. Hereinafter, the two relay networks NW1 and NW2 will be referred to as relay networks NW when there is no need to specifically distinguish between the two. The relay networks NW may be, for example, Ethernet (registered trademark) networks although not limited particularly.

The first uninterruptible apparatus UA1 serving as a transmission apparatus is connected with a first high-speed user terminal HST1 configured to accept input of main signals MS to be transmitted to the first uninterruptible apparatus UA1 through a main signal channel and with a first low-speed user terminal LST1 configured to accept input of a sub-signal SS to be transmitted through a sub-signal channel. The main signals MS are, for example, user data frames containing a header and a data payload while the sub-signal SS is a user data signal which is a code sequence made up of 0s and 1s. On the other hand, the second uninterruptible apparatus UA2 serving as a reception apparatus is connected with a second high-speed user terminal HST2 configured to accept input of main signals MS received from the second uninterruptible apparatus UA2 and with a second low-speed user terminal LST2 configured to accept input of a received sub-signal SS.

The first uninterruptible apparatus UA1 serving as a transmission apparatus assigns sequence numbers to the inputted main signals MS, indicating the order of the main signals MS, duplicates the main signals MS according to the number of relay routes RR, and sends out the main signals MS to each of the relay routes RR. In so doing, based on the sub-signal SS accepted as input, the first uninterruptible apparatus UA1 adjusts sending timings of the main signals MS for each relay route RR. For example, the first uninterruptible apparatus UA1 converts the sub-signal SS into a delay, discards the sub-signal SS itself and gives the delay obtained by the conversion to communications of the main signals MS. Therefore, of the signals, only the main signals MS flow through the relay routes RR.

The second uninterruptible apparatus UA2 serving as a reception apparatus selects a main signal MS to be outputted to the second high-speed user terminal HST2, according to the reception timings of the main signals MS passing through the respective relay routes RR. For example, based on the sequence number assigned to each received main signal MS, the second uninterruptible apparatus UA2 distinguishes the main signal MS arriving first, deletes the sequence number from the first-arriving main signal MS, and outputs the main signal MS to the second high-speed user terminal HST2. The second uninterruptible apparatus UA2 discards the main signal MS arriving later.

In FIG. 1, the main signals MS arriving first through the first relay route RR1 are indicated by hatched rectangles and the main signals MS arriving first through the second relay route RR2 are indicated by grid-patterned rectangles, thereby being distinguished from each other. Hollow rectangles without hatching indicate main signals MS arriving later. Note that the numerals in the rectangles that indicate main signals MS are sequence numbers.

The second uninterruptible apparatus UA2 decodes the sub-signal SS based on which of the relay routes RR the selected main signal has passed, and outputs the sub-signal SS to the second low-speed user terminal LST2. For example, the second uninterruptible apparatus UA2 determines which of the relay routes RR the selected first-arriving main signal MS has passed, and converts a sequence of the relay routes RR that has received the first-arriving main signals MS into a code sequence made up of 0s and 1s.

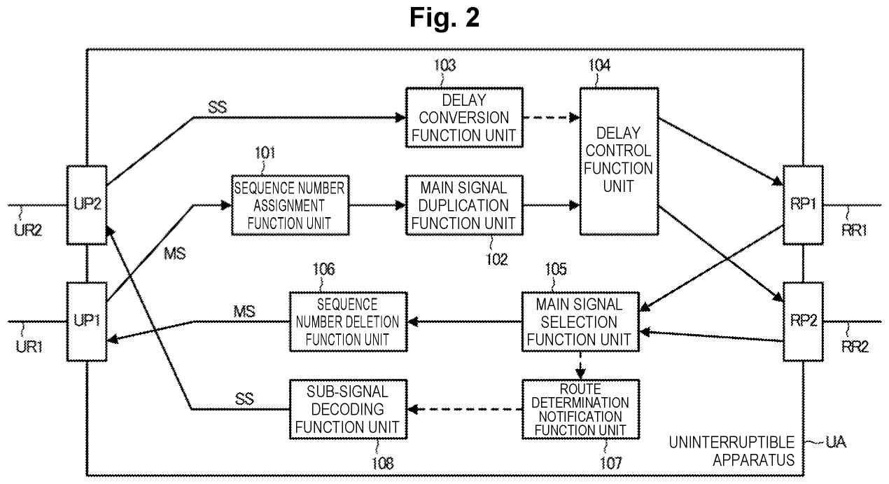

FIG. 2 is a block diagram showing an exemplary functional configuration of the uninterruptible apparatus UA.

The first uninterruptible apparatus UA1 and the second uninterruptible apparatus UA2 can have a same configuration. That is, whereas the first uninterruptible apparatus UA1 is a transmission apparatus and the second uninterruptible apparatus UA2 is a reception apparatus in the example shown in FIG. 1, this may be the other way around. In other words, with the second uninterruptible apparatus UA2 serving as a transmission apparatus and the first uninterruptible apparatus UA1 serving as a reception apparatus, the main signal MS from the second high-speed user terminal HST2 and the sub-signal SS from the second low-speed user terminal LST2 may be transmitted to the first high-speed user terminal HST1 and the first low-speed user terminal LST1. Hereinafter, the first high-speed user terminal HST1 and the second high-speed user terminal HST2 will be referred to as high-speed user terminals HST when there is no need to specifically distinguish between the two. Similarly, the two low-speed user terminals LST1 and LST2 will be referred to as low-speed user terminals LST when there is no need to specifically distinguish between the two. Besides, needless to say, by dividing the components of the uninterruptible apparatus UA in FIG. 2 into components related to transmission and components related to reception, the transmission apparatus and the reception apparatus may be formed separately. Note that in FIG. 2, the solid arrows indicate flows of main signals MS or sub-signals SS while the dashed arrows indicate flows of control signals.

In the example of FIG. 2, as functional components related to transmission, the uninterruptible apparatus UA includes a sequence number assignment function unit 101, a main signal duplication function unit 102, a delay conversion function unit 103, and a delay control function unit 104. Also, as functional components related to reception, the uninterruptible apparatus UA includes a main signal selection function unit 105, a sequence number deletion function unit 106, a route determination notification function unit 107, and a sub-signal decoding function unit 108. Furthermore, the uninterruptible apparatus UA includes a first user port UP1 and a second user port UP2 as well as a first relay port RP1 and a second relay port RP2. Hereinafter, the first user port UP1 and the second user port UP2 will be referred to as user ports UP when there is no need to specifically distinguish between the two. Similarly, the two relay ports RP1 and RP2 will be referred to as relay ports RP when there is no need to specifically distinguish between the two.

Here, the first user port UP1 is used to receive the main signals MS inputted from the high-speed user terminal HST on the sending end via a first user route UR1 and transmit the main signals MS outputted to the high-speed user terminal HST on the receiving end via the first user route UR1. The second user port UP2 is used to receive the sub-signal SS inputted from the low-speed user terminal LST on the sending end via a second user route UR2 and transmit the sub-signal SS outputted to the low-speed user terminal LST on the receiving end via the second user route UR2. Hereinafter, the first user route UR1 and the second user route UR2 will be referred to as user routes UR when there is no need to specifically distinguish between the two. The first relay port RP1 is used to transmit main signals MS with or without a delay to the first relay route RR1 and receive main signals MS with or without a delay from the first relay route RR1. The second relay port RP2 is used to transmit main signals MS with or without a delay to the second relay route RR2 and receive main signals MS with or without a delay from the second relay route RR2.

The sequence number assignment function unit 101 assigns sequence numbers to the main signals MS received at the first user port UP1 and to be transmitted through the main signal channel, to identify the order of the main signals. For example, when the main signals MS are user data frames, the sequence number assignment function unit 101 adds sequence numbers for use to identify the order of the frames to headers or part of payloads. The sequence number assignment function unit 101 supplies the main signals MS with the sequence numbers assigned thereto to the main signal duplication function unit 102.

The main signal duplication function unit 102 duplicates the main signal MS assigned a sequence number supplied from the sequence number assignment function unit 101, according to the number of redundant routes, i.e., according to the number of relay ports possessed by the uninterruptible apparatus UA. According to the present embodiment, since the uninterruptible apparatus UA has two relay ports RP, the main signal duplication function unit 102 creates one duplicate of the main signal MS assigned a sequence number by the sequence number assignment function unit 101, and thereby obtains two copies of the main signal MS. The main signal duplication function unit 102 supplies the delay control function unit 104 with the two copies of the main signal MS assigned the sequence number.

The delay conversion function unit 103 converts the sub-signal SS received at the second user port UP2 and to be transmitted through the sub-signal channel into a delay. For example, when the sub-signal SS is a user data signal which is a code sequence made up of 0s and 1s, based on the 0s and 1s, which are values of bits in the user data signal, the delay conversion function unit 103 can determine how much delay to be given to which of the main signal MS to be sent out from the first relay port RP1 and the main signal MS to be sent out from the second relay port RP2. The delay conversion function unit 103 supplies the delay conversion result to the delay control function unit 104.

The delay control function unit 104 sends out the two copies of the main signal MS assigned the sequence number, to the two relay ports RP, the two copies having been supplied from the main signal duplication function unit 102, and thereby transmits the two copies of the main signal MS to the uninterruptible apparatus UA on the receiving end via redundant routes, i.e., the two relay routes RR. In sending out the two copies of the main signal MS assigned the sequence number, to the two relay ports RP, the delay control function unit 104 controls the sending timings of the two copies of the main signal MS based on the delay conversion result supplied from the delay conversion function unit 103. The timing control will be described in detail later.

When a main signal MS assigned a sequence number is received by either of the two relay ports RP, the main signal selection function unit 105 determines whether the received main signal MS has arrived at the uninterruptible apparatus UA first or later. This can be determined by referring to the sequence number assigned to the received main signal MS. The main signal selection function unit 105 selects the first-arriving main signal MS and supplies the selected main signal MS to the sequence number deletion function unit 106 while discarding the main signal MS arriving later. Then, the main signal selection function unit 105 supplies first-arrival route information indicating the relay port that has received the first-arriving main signal MS, i.e., the relay route RR to the route determination notification function unit 107.

The sequence number deletion function unit 106 deletes the sequence number from the main signal MS supplied from the main signal selection function unit 105. The sequence number deletion function unit 106 sends out the main signal MS from which the sequence number has been deleted to the first user port UP1 and thereby sends out the main signal MS to the high-speed user terminal HST on the receiving end via the first user route UR1.

Based on the first-arrival route information supplied from the main signal selection function unit 105, the route determination notification function unit 107 determines which relay route RR out of the redundant routes the first-arriving main signal MB has passed. The route determination notification function unit 107 notifies the sub-signal decoding function unit 108 about the determination result.

The sub-signal decoding function unit 108 decodes the sub-signal SS transmitted through the sub-signal channel, based on the determination result sent from the route determination notification function unit 107. For example, the sub-signal decoding function unit 108 decodes the sub-signal SS into a bit value of 0 if the first-arriving main signal MS has passed the first relay route RR1, and into a bit value of 1 if the first-arriving main signal MS has passed the second relay route RR2. By converting the sequence of the relay routes RR that has received the first-arriving main signals MS into a code sequence made up of 0s and 1s in this way, the sub-signal decoding function unit 108 can decode the sub-signal SS. The sub-signal decoding function unit 108 sends out the decoded sub-signal SS to the second user port UP2, and thus to the low-speed user terminal LST on the receiving end via the second user route UR2.

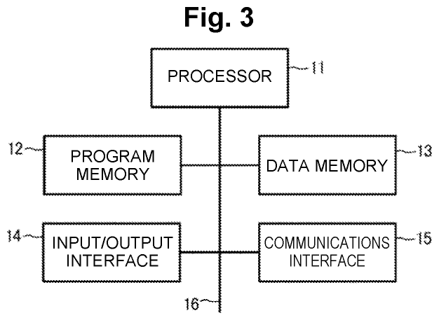

FIG. 3 is a diagram showing an exemplary hardware configuration of the uninterruptible apparatus UA.

As shown in FIG. 3, the uninterruptible apparatus UA can be made up of a computer. The uninterruptible apparatus UA includes a hardware processor 11A such as a CPU (Central Processing Unit). In the uninterruptible apparatus UA, the processor 11 is connected with a program memory 12, a data memory 13, input/output interfaces 14, and communications interface 15s via a bus 16.

The program memory 12, which is a non-transitory tangible computer-readable storage medium, is made up of a combination of, for example, a nonvolatile memory, such as an HDD (Hard Disk Drive) or an SSD (Solid State Drive), which allows random read/write access, and a nonvolatile memory such as a ROM. Programs needed for the processor 11 in performing various control processes according to the present embodiment are stored in the program memory 12. That is, the sequence number assignment function unit 101, the main signal duplication function unit 102, the delay conversion function unit 103, the delay control function unit 104, the main signal selection function unit 105, the sequence number deletion function unit 106, the route determination notification function unit 107, and the sub-signal decoding function unit 108 shown in FIG. 2 may all be implemented when the programs stored in the program memory 12 are read out and executed by the processor 11. Note that some or all of the processing functional components may be implemented in various other forms including integrated circuits such as application specific integrated circuits (ASICs) or field-programmable gate arrays (FPGAs).

The data memory 13, which is a tangible computer-readable storage medium, is made up of a combination of, for example, a nonvolatile memory such as described above and a volatile memory such as a RAM (Random Access Memory). The data memory 13 is used to store various data acquired and created in the course of performing various processes. That is, the data memory 13 provides areas for use to store various data as appropriate in the course of performing various processes.

The input/output interfaces 14, which are the user ports UP1 and UP2 shown in FIG. 2, can be connected with the high-speed user terminal HST and the low-speed user terminal LST via the user routes UR1 and UR2.

The communications interfaces 15, which are the relay ports RP1 and RP2 shown in FIG. 2, can be connected with the communications interfaces 15 of the other uninterruptible apparatus UA via the relay routes RR1 and RR2. The communications interfaces 15 are not limited to ports, and may include communications modules corresponding to a communications medium of the relay paths RR, a communications method, and a communications protocol.

(Operation)

Next, operation of the uninterruptible apparatus UA will be described.

Description will be given below by assuming that the main signals MS are user data frames and the sub-signal SS is a user data signal. Needless to say, the present invention is not limited to this.

When the uninterruptible apparatus UA is made up of a computer such as shown in FIG. 3, by executing a program stored in the program memory 12, the processor 11 can operate as functional components of the uninterruptible apparatus UA.

When a user data frame, which is a main signal MS, is inputted to the first user port UP1, if a user data signal, which is a sub-signal SS, is not inputted to the second user port UP2, the processor 11 duplicates the user data frame by assigning a sequence number to the user data frame as with conventional techniques such as disclosed in Patent Literature 1. Then, the processor 11 sends out the user data frames assigned the sequence number, to the two relay ports RP and thereby transmits the user data frames from the respective relay ports RP to the uninterruptible apparatus UA on the receiving end via the respective relay routes RR. In so doing, since a user data signal, which is a sub-signal SS, has not been inputted, no delay is given to the two user data frames to be transmitted.

In contrast, when a user data frame, which is a main signal MS, is inputted to the first user port UP1 and a user data signal, which is a sub-signal SS, is inputted to the second user port UP2, the processor 11 operates as follows.

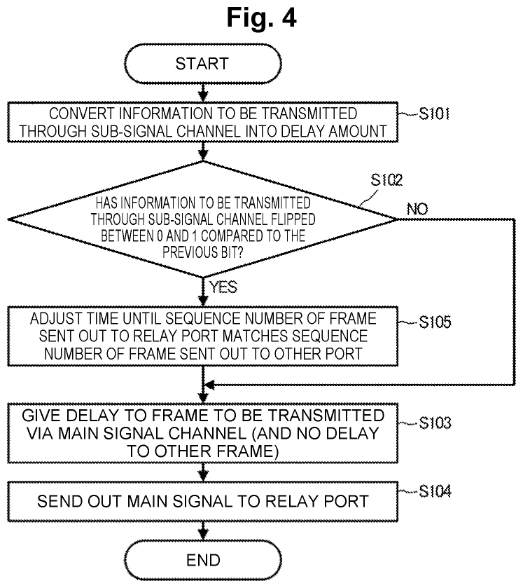

FIG. 4 is a flowchart showing an exemplary transmission processing operation of the uninterruptible apparatus UA in this case. A program needed in order to perform the control process shown in the flowchart has been stored in the program memory 12 of the uninterruptible apparatus UA, and by executing the program, the processor 11 can operate as the delay conversion function unit 103 and the delay control function unit 104 of the uninterruptible apparatus UA. The assignment of sequence numbers and the duplication of main signals MS are similar to those of conventional techniques such as disclosed in Patent Literature 1, and thus description thereof will be omitted here.

Each time one frame in the frame sequence of user data frames, which are main signals MS, is inputted to the first user port UP1 and one bit in the data sequence of a user data signal, which is a sub-signal SS, is inputted to the second user port UP2, the processor 11 performs the transmission processing operation shown in the flowchart.

That is, when a main signal MS and a sub-signal SS are inputted, first the processor 11 converts the bit of the user data signal serving as the sub-signal SS, which is information transmitted through the sub-signal channel into a delay amount (step S101). For example, if the bit value of the user data signal is 0, the processor 11 gives a delay of 0 to the user data frame serving as the main signal MS to be sent out from the first relay port RP1 to the first relay route RR1 and gives a delay to the user data frame to be sent out from the second relay port RP2 to the second relay route RR2 by setting the amount of delay to α. The delay amount α is set larger than a maximum value of a delay difference the two relay routes RR are likely to have. Consequently, even if a short route and a long route switch from one to the other due to a delay in the redundant section, operation on the receiving end can remain unaffected.

Next, the processor 11 compares the bit value of the user data signal serving as the sub-signal SS, which is information inputted this time and to be transmitted through the sub-signal channel with the value of the previous bit and distinguishes whether the bit value has been flipped between 0 and 1 (step S102). The value of the previous bit used for comparison is stored in the data memory 13. When shifting from the determination process of step S102 to a subsequent control process, the processor 11 saves the current bit value of the user data signal in the data memory 13 by overwriting the previous bit value.

If it is determined in step S102 above that the bit value has not been flipped (NO in step S102), of the main signals MS to be transmitted through the main signal channel, the processor 11 gives a delay having a delay amount α to the user data frame to be transmitted via one of the relay routes RR (step S103). In so doing, no delay (a delay of 0) is given to the user data frame to be transmitted via the other relay route RR. Which user data frame a delay is to be given depends on the determination result produced in step S101 above. For example, if the bit value of the user data signal, which is a sub-signal SS, is 0, the processor 11 gives a delay having a delay amount α to the user data frame, which is a main signal MS to be transmitted via the second relay route RR2. On the other hand, if the bit value of the user data signal, which is a sub-signal SS, is 1, the processor 11 gives a delay having a delay amount α to the user data frame, which is a main signal MS to be transmitted via the first relay route RR1.

Subsequently, the processor 11 sends out the user data frame, which is a main signal MS, to the two relay ports RP and thereby transmits the main signal MS to the uninterruptible apparatus UA on the receiving end from the relay ports RP via the respective relay routes RR (step S104). In this case, however, the processor 11 sends out the main signal MS given the delay, to the corresponding relay port RP after a lapse of the delay amount α from the main signal MS without a delay. Then, the processor 11 finishes the transmission processing operation shown in the flowchart and waits for input of a next main signal MS and sub-signal SS.

On the other hand, if it is determined in step S102 above that the bit value has been flipped (YES in step S102), the processor 11 adjusts the time until the sequence number of the user data frame, which is the main signal MS given the delay and sent out to the relay port RP matches the sequence number of the user data frame, which is the main signal MS given no delay and already sent out to the other relay port RP (step S105). A waiting time β for time adjustment may be, for example, equal to the delay amount α described above (delay amount α=waiting time β). By taking into consideration delays caused by data processing in the uninterruptible apparatus UA and by data transmission, and by detecting frame sending status at the other relay port RP, the waiting time β may be set to the time until a match between the sequence numbers is detected (delay amount α<waiting time β). When the waiting time β elapses, the processor 11 advances the control process to step S103 described above.

Consequently, for example, if the bit value of the user data signal, which is a sub-signal SS, changes from 0 to 1, the processor 11 waits for the waiting time β, and then gives a delay having a delay amount α to the user data frame, which is a main signal MS to be transmitted via the first relay route RR1. On the other hand, if the bit value of the user data signal, which is a sub-signal SS, changes from 1 to 0, the processor 11 waits for the waiting time β, and then gives a delay having a delay amount α to the user data frame, which is a main signal MS to be transmitted via the second relay route RR2.

Subsequently, the processor 11 advances the control process to step S104 described above, and sends out the user data frame, which is a main signal MS, to each of the two relay ports RP at the right time according to the presence or absence of a delay and thereby transmits the user data frame to the uninterruptible apparatus UA on the receiving end from the relay ports RP via the respective relay routes RR. Then, the processor 11 finishes the transmission processing operation shown in the flowchart and waits for input of a next main signal MS and sub-signal SS.

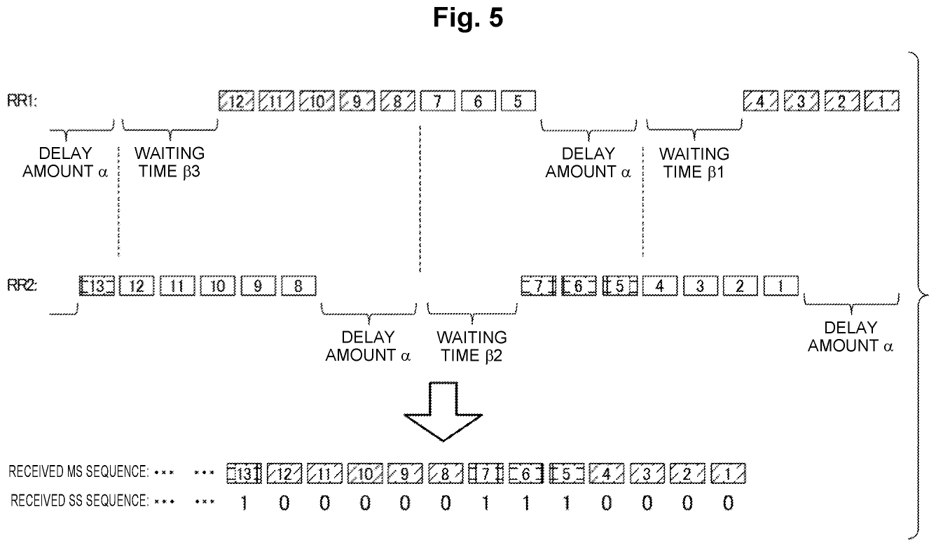

FIG. 5 is a schematic diagram for explaining operation of the communications system according to the present embodiment.

When a main signal MS and a sub-signal SS are inputted, for example, if the bit value of the user data signal, which is a sub-signal SS, is 0, in step S101 described above, the processor 11 sets the delay amount of the main signal MS to be sent out from the first relay port RP1 to the first relay route RR1 to 0 and sets the delay amount of the main signal MS to be sent out from the second relay port RP2 to the second relay route RR2 to α. Subsequently, the processor 11 distinguishes in step S102 above whether the bit value of the user data signal, which is a sub-signal SS, has been flipped between 0 and 1 compared to the previous bit value. Regarding the first bit of the user data signal, since there is no previous bit value, the processor 11 determines that the determination in step S102 above is NO and advances the control process to step S103 described above. Since the bit value of the user data signal in step S103 above is 0, the processor 11 gives a delay having a delay amount α to the main signal MS to be transmitted via the second relay route RR2. Subsequently, in step S104 described above, the processor 11 sends out the user data frame, which is a main signal MS, to each of the two relay ports RP at the right time according to the presence or absence of a delay. Consequently, as shown in the upper part of FIG. 5 (above the open arrow), the user data frame assigned a sequence number of 1 is transmitted from the first relay route RR1. At this time, the user data frame bound for the second relay route RR2 is yet to be transmitted because of the delay.

Subsequently, user data frames assigned sequence numbers 2 to 4 are transmitted in sequence from the first relay route RR1 in a similar manner.

On the second relay route RR2, a user data frame assigned a sequence number of 1 is transmitted after a lapse of the delay amount α from when a corresponding user data frame is transmitted from the first relay route RR1. In the example of FIG. 5, the lapse of the delay amount α coincides with the time when a user data frame assigned a sequence number of 3 is transmitted from the first relay route RR1. Subsequently, the user data frames assigned the sequence numbers 2 to 4 are transmitted in sequence from the second relay route RR2.

Then, for example, when the fifth bit value of the user data signal, which is a sub-signal SS, becomes 1, in step S101 described above, the processor 11 sets the delay amount of the user data frame, which is the main signal MS to be sent out from the first relay port RP1 to the first relay route RR1, to α and sets the delay amount of the user data frame to be sent out from the second relay port RP2 to the second relay route RR2 to 0. Subsequently, the processor 11 distinguishes in step S102 above whether the bit value of the user data signal has been flipped between 0 and 1 compared to the previous bit value. In this case, since the fourth bit and fifth bit of the user data signal have been flipped between 0 and 1, the processor 11 determines that the determination in step S102 above is YES and advances the control process to step S105 described above. In step S105 described above, the processor 11 adjusts a waiting time β1, i.e., the time until the sequence number of the user data frame sent out to the second relay port RP2 and given a delay matches 4, which is the sequence number of the user data frame already sent out to the first relay port RP1 and given no delay. After a lapse of the waiting time β1, the processor 11 advances the control process to step S103 described above, and then to step S104 described above. Consequently, the user data frame assigned a sequence number of 5 is transmitted from the second relay route RR2. At this time, the user data frame bound for the first relay route RR1 is yet to be transmitted because of the delay.

Subsequently, the user data frames assigned the sequence numbers 6 and 7 are transmitted in sequence from the second relay route RR2 in a similar manner.

On the first relay route RR1, a user data frame assigned a sequence number of 5 is transmitted after a lapse of the delay amount α from when a corresponding user data frame is transmitted from the second relay route RR2. In the example of FIG. 5, the lapse of the delay amount α coincides with the time when a user data frame assigned a sequence number of 7 is transmitted from the second relay route RR2. Subsequently, the user data frames assigned the sequence numbers 6 to 7 are transmitted in sequence from the first relay route RR1.

Then, for example, when the eighth bit value of the user data signal, which is a sub-signal SS, becomes 0 again, in step S101 described above, the processor 11 sets the delay amount of the user data frame, which is the main signal MS to be sent out from the second relay port RP2 to the second relay route RR2, to α and sets the delay amount of the user data frame to be sent out from the first relay port RP1 to the first relay route RR1, to 0. Subsequently, since the seventh bit and eighth bit of the user data signal have been flipped between 0 and 1, the processor 11 determines that the determination in step S102 above is YES and advances the control process to step S105 described above. In step S105 described above, the processor 11 adjusts a waiting time β2, i.e., the time until the sequence number of the user data frame sent out to the first relay port RP1 and given a delay matches 7, which is the sequence number of the user data frame already sent out to the second relay port RP2 and given no delay. After a lapse of the waiting time β2, the processor 11 advances the control process to step S103 described above, and then to step S104 described above. Consequently, the user data frame assigned a sequence number of 8 is transmitted from the first relay route RR1. At this time, the user data frame bound for the second relay route RR2 is yet to be transmitted because of the delay.

Subsequently, the user data frames assigned the sequence numbers 9 to 12 are transmitted in sequence from the first relay route RR1 in a similar manner.

On the second relay route RR2, a user data frame assigned a sequence number of 8 is transmitted after a lapse of the delay amount α from when a corresponding user data frame is transmitted from the first relay route RR1. In the example of FIG. 5, the lapse of the delay amount α coincides with the time when a user data frame assigned a sequence number of 10 is transmitted from the first relay route RR1. Subsequently, the user data frames assigned the sequence numbers 8 to 12 are transmitted in sequence from the second relay route RR2.

Then, for example, when the 13th bit value of the user data signal, which is a sub-signal SS, becomes 1 again, in step S101 described above, the processor 11 sets the delay amount of the user data frame, which is the main signal MS to be sent out from the first relay port RP1 to the first relay route RR1, to α and sets the delay amount of the user data frame to be sent out from the second relay port RP2 to the second relay route RR2 to 0. Subsequently, since the 12th bit and 13th bit of the user data signal have been flipped between 0 and 1, the processor 11 determines that the determination in step S102 above is YES and advances the control process to step S105 described above. In step S105 described above, the processor 11 adjusts a waiting time β3, i.e., the time until the sequence number of the user data frame sent out to the second relay port RP2 and given a delay matches 12, which is the sequence number of the user data frame already sent out to the first relay port RP1 and given no delay. After a lapse of the waiting time β3, the processor 11 advances the control process to step S103 described above, and then to step S104 described above. Consequently, the user data frame assigned a sequence number of 13 is transmitted from the second relay route RR2. At this time, the user data frame bound for the first relay route RR1 is yet to be transmitted because of the delay.

Subsequently, the user data frames assigned the sequence number 14 or subsequent sequence numbers are transmitted in sequence from the second relay route RR2 in a similar manner. On the first relay route RR1, a user data frame assigned a sequence number of 13 is transmitted after a lapse of the delay amount α from when a corresponding user data frame is transmitted from the second relay route RR2. Subsequently, the user data frames assigned the sequence number 14 or subsequent sequence numbers are transmitted in sequence from the first relay route RR1.

Next, operation of the uninterruptible apparatus UA on the receiving end will be described.

When the first frame of the frame sequence of user data frames, which are main signals MS, is received at either of the relay ports RP, the processor 11 waits for the first frame of the frame sequence of user data frames to be received at the other relay port RP. When the first frame is received at the other relay port RP, the processor 11 deletes the sequence number from one of the received copies of the first frame of the frame sequence of user data frames, e.g., from the first-arriving user data frame. Then, the processor 11 sends out the user data frame with the sequence number deleted therefrom to the first user port UP1 and thereby transmits the user data frame from the first user port UP1 to the second high-speed user terminal HST2 on the receiving end via the first user route UR1. The user data frame arriving later is discarded. Regarding the second and subsequent user data frames, similarly the first-arriving user data frame is sent out to the first user port UP1 and then transmitted to the second high-speed user terminal HST2.

The processor 11 sets the waiting time for reception of the user data frame assigned the same sequence number to a fixed duration with a transmission delay on the relay route RR taken into consideration. If the user data frame assigned the same sequence number is not received at the other relay port RP after a lapse of the fixed duration, the processor 11 may send out the already received user data frame to the first user port UP1 and thereby transmit the user data frame to the second high-speed user terminal HST2 by presuming that a frame loss has occurred due to disconnection of one of the routes.

However, regarding the first frame of the frame sequence of user data frames, if the frame is not received at the other relay port RP even after a lapse of the fixed duration, the processor 11 determines that the user data frame bound for the other relay route RR has been given the delay amount α on the receiving end, i.e., the sub-signal SS has been multiplexed, and operates as follows.

Note that the method for distinguishing multiplexing is exemplary and another method may be used for distinction such as transmitting in advance an identifying signal indicating the presence or absence of multiplexing, and the present invention does not specifically limit the distinction method.

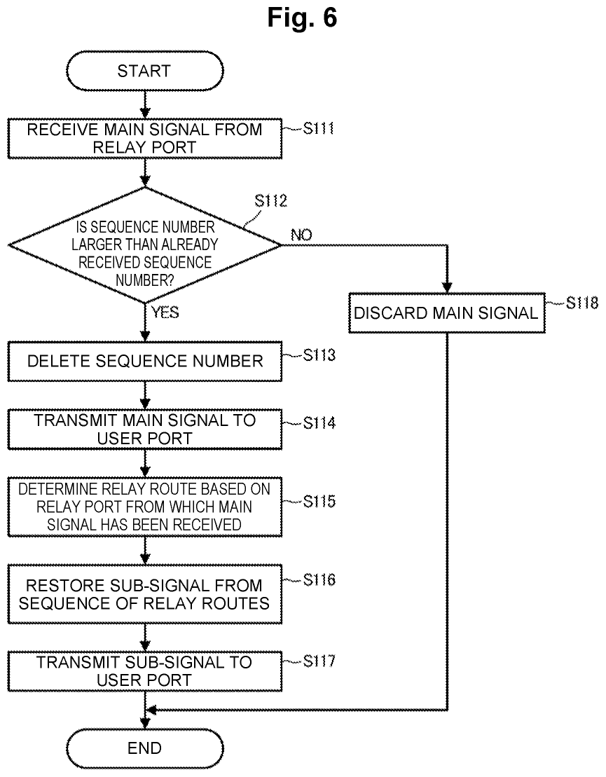

FIG. 6 is a flowchart showing an exemplary reception processing operation of the uninterruptible apparatus UA in this case. A communications program needed in order to perform the control process shown in the flowchart has been stored in the program memory 12 of the uninterruptible apparatus UA, and by executing the communications program, the processor 11 can operate as the main signal selection function unit 105, sequence number deletion function unit 106, route determination notification function unit 107, and sub-signal decoding function unit 108 of the uninterruptible apparatus UA.

When a user data frame, which is a main signal MS, is received at either of the relay ports RP, the processor 11 receives the user data frame from the relay port RP (step S111). Regarding the first frame of the frame sequence of user data frames, which has already been received, step S111 is skipped.

Then, the processor 11 determines whether the sequence number assigned to the received user data frame is larger than the already received sequence number (step S112). Note that the already received sequence numbers used for comparison are stored in the data memory 13.

If it is determined in step S112 above that the sequence number assigned to the newly received user data frame is larger than the already received sequence number (YES in step S112), the processor 11 deletes the sequence number from the received user data frame (step S113). In so doing, the processor 11 saves the deleted sequence number in the data memory 13 in order to use the sequence number for comparison in step S112 described above. Then, the processor 11 sends out the user data frame, which is the main signal MS from which the sequence number has been deleted, to the first user port UP1 and thereby transmits the user data frame from the first user port UP1 to the second high-speed user terminal HST2 on the receiving end via the first user route UR1 (step S114).

Based on whether the relay port RP having received the user data frame is the first relay port RP1 or the second relay port RP2, the processor 11 determines the relay route RR through which the user data frame, which is a main signal MS, has been transmitted (step S115). The processor 11 assigns 0 to the first relay route RR1 and assigns 1 to the second relay route RR2 among a sequence of the determined relay routes RR and thereby restores the user data signal, which is a sub-signal SS (step S116). Subsequently, the processor 11 sends out the user data signal, which is a sub-signal SS, to the second user port UP2 and thereby transmits the user data signal from the second user port UP2 to the second low-speed user terminal LST2 on the receiving end via the second user route UR2 (step S117). Then, the processor 11 finishes the reception processing operation shown in the flowchart and waits for reception of a user data signal, which is a next main signal MS.

If it is determined in step S112 above that the sequence number assigned to the user data frame, which is a newly received main signal MS, is not larger than the already received sequence number (NO in step S112), the processor 11 discards the received user data frame (step S118). In other words, a newly received user data frame, which coincides with an already received user data frame, is discarded. Then, the processor 11 finishes the reception processing operation shown in the flowchart and waits for reception of a user data signal, which is a next main signal MS.

In an example such as shown in the upper part of FIG. 5, on the uninterruptible apparatus UA on the receiving end, as shown in the lower part of FIG. 5 (below the open arrow), the relay routes RR through which user data frames with respective sequence numbers arrive first are: the first relay route RR1 (sequence number 1), the first relay route RR1 (sequence number 2), the first relay route RR1 (sequence number 3), the first relay route RR1 (sequence number 4), the second relay route RR2 (sequence number 5), the second relay route RR2 (sequence number 6), the second relay route RR2 (sequence number 7), the first relay route RR1 (sequence number 8), the first relay route RR1 (sequence number 9), the first relay route RR1 (sequence number 10), the first relay route RR1 (sequence number 11), the first relay route RR1 (sequence number 12), the second relay route RR2 (sequence number 13), . . . . Therefore, in step S116 described above, the processor 11 assigns “0” to the first relay route RR1 and assigns “1” to the second relay route RR2, and thereby restores bit values “0000111000001 . . . ” of the user data signal.

Thus, on the uninterruptible apparatus UA on the sending end, by adjusting transmission timings of the user data frames, which are main signals to be transmitted through the main signal channel, on each relay route RR according to the user data signal, which is the sub-signal to be transmitted through the sub-signal channel, the passage route for main signals MS selected on a first-come basis on the uninterruptible apparatus UA on the receiving end is changed intentionally. Then, on the uninterruptible apparatus UA on the receiving end, the first-arriving user data frame is selected as the main signal MS transmitted through the main signal channel, and the user data signal, which is a sub-signal SS transmitted through the sub-signal channel, is restored based on the relay route RR through which the first-arriving user data frame has been transmitted. This makes it possible to multiplex communications of main signals MS and communications of sub-signals SS without assigning identifiers to main signals MS on redundant routes.

### Second Embodiment

(Configuration)

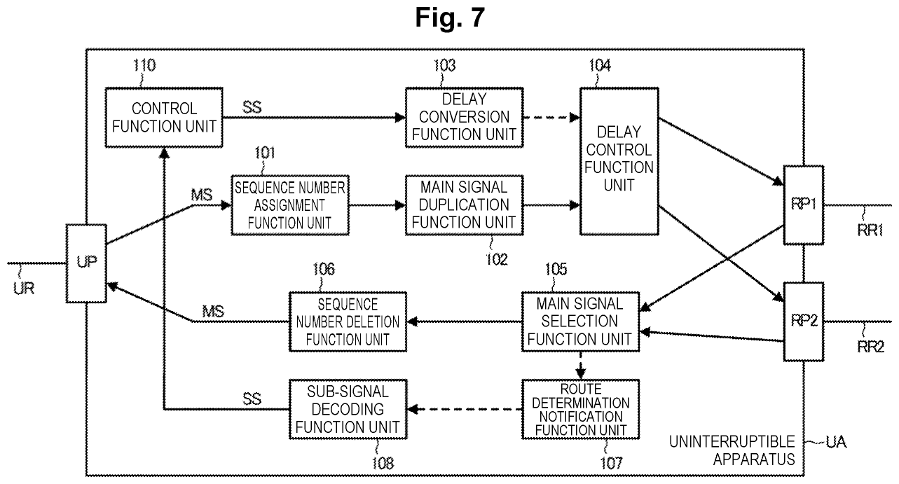

FIG. 7 is a block diagram showing an exemplary configuration of an uninterruptible apparatus UA in a communications system according to a second embodiment of the present invention. Components corresponding to those of the first embodiment are denoted by the same reference signs as the corresponding components of the first embodiment, and description thereof will be omitted. Differences from the first embodiment will be described below.

According to the present embodiment, the uninterruptible apparatus UA has only one user port UP corresponding to the first user port UP1 according to the first embodiment. That is, the user port UP is connected to the user route UR coming from the high-speed user terminal HST. According to the present embodiment, the second user port UP2 according to the first embodiment is not provided.

The uninterruptible apparatus UA according to the present embodiment includes a control function unit 110. The control function unit 110 generates a control signal as a sub-signal SS to be transmitted through the sub-signal channel, where the control signal is used for operations, administration, and maintenance of a network, such as Ethernet OAM (Ethernet Operations, Administration, Maintenance) functions including alive monitoring, frame loss measurement, and delay measurement. The control function unit 110 supplies the generated sub-signal SS to the delay conversion function unit 103. The control function unit 110 may be implemented when a program stored in the program memory 12 is read out and executed by the processor 11.

The sub-signal decoding function unit 108 supplies the decoded sub-signal SS to the control function unit 110.

(Operation)

Operation of the uninterruptible apparatus UA according to the second embodiment is similar to that of the first embodiment described above except that the sub-signal SS is inputted to/outputted from the control function unit 110 inside the uninterruptible apparatus UA rather than the low-speed user terminal LST outside the uninterruptible apparatus UA. Thus, description of the operation will be omitted.

Thus, the second embodiment can achieve effects similar to those of the first embodiment. The sub-signal SS can be configured as an internal signal of the uninterruptible apparatus UA.

### Third Embodiment

(Configuration)

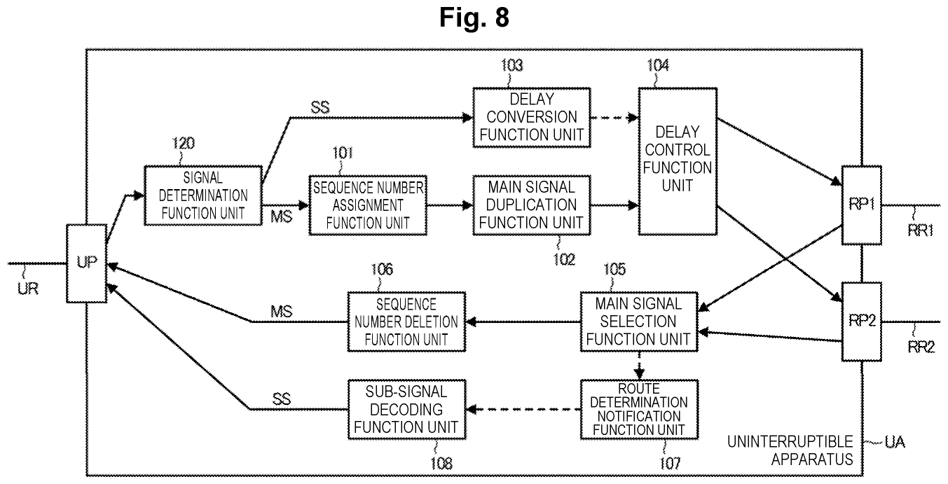

FIG. 8 is a block diagram showing an exemplary configuration of an uninterruptible apparatus UA in a communications system according to a third embodiment of the present invention. Components corresponding to those of the first embodiment are denoted by the same reference signs as the corresponding components of the first embodiment, and description thereof will be omitted. Differences from the first embodiment will be described below.

According to the present embodiment, the uninterruptible apparatus UA has only one user port UP corresponding to the first user port UP1 according to the first embodiment. That is, the user port UP is connected to the user route UR coming from the high-speed user terminal HST. According to the present embodiment, the second user port UP2 according to the first embodiment is not provided. Note that the high-speed user terminal HST inputs both the main signal MS to be transmitted through the main signal channel and sub-signal SS to be transmitted through the sub-signal channel to the uninterruptible apparatus UA. In this case, the main signal MS and the sub-signal SS can be inputted as time series signals, in which the main signal MS is inputted after an entire bit sequence of the sub-signal SS is inputted. As a superimposed signal in which two signals are superimposed by some technique, the main signal MS and the sub-signal SS may be inputted to the uninterruptible apparatus UA.

The uninterruptible apparatus UA according to the present embodiment includes a signal determination function unit 120. The signal determination function unit 120 classifies the signals inputted to the user port UP into the main signal MS to be transmitted through the main signal channel and the sub-signal SS to be transmitted through the sub-signal channel. The signal determination function unit 120 supplies the main signal MS resulting from the classification, to the sequence number assignment function unit 101 and supplies the sub-signal SS resulting from the classification, to the delay conversion function unit 103. The signal determination function unit 120 may be implemented when a program stored in the program memory 12 is read out and executed by the processor 11. Besides, when the main signal MS and the sub-signal SS are configured to be inputted as a superimposed signal, the signal determination function unit 120 includes a memory for use to temporarily save the inputted signal. As the memory, the data memory 13 can be used. The signal determination function unit 120 saves all the superimposed signals of the main signal MS and sub-signal SS to be transmitted in the memory, and separates the main signal MS and the sub-signal SS using a separation method according to a superimposing technique.

The sub-signal decoding function unit 108 sends out the decoded sub-signal SS to the user port UP and thereby transmits the decoded sub-signal SS to the high-speed user terminal HST on the receiving end via the user route UR.

(Operation)

In the uninterruptible apparatus UA according to the third embodiment, the processor 11 that implements the signal determination function unit 120 classifies the signals inputted to the user port UP into the main signal MS to be transmitted through the main signal channel and the sub-signal SS to be transmitted through the sub-signal channel. Then, the processor 11 supplies the main signal MS resulting from the classification, to the sequence number assignment function unit 101 and supplies the sub-signal SS resulting from the classification, to the delay conversion function unit 103. Subsequent operations are similar to those of the first embodiment described above, and thus description thereof will be omitted.

Thus, the third embodiment can achieve effects similar to those of the first embodiment. Besides, the third embodiment makes it possible to communicate the main signal MS and sub-signal SS inputted from a single high-speed user terminal HST.

Note that the uninterruptible apparatus UA may include a signal combining unit configured to combine a main signal MS with the sequence number deleted therefrom and a decoded sub-signal SS on the receiving end using a technique corresponding to an input signal and output the combined signal from the user port UP.

### Fourth Embodiment

(Configuration)

A fourth embodiment of the present invention can adopt a configuration of the uninterruptible apparatus UA similar to any of the first to third embodiments. However, the delay control function unit 104 and the sub-signal decoding function unit 108 differ in operation from those of the above embodiments.

(Operation)

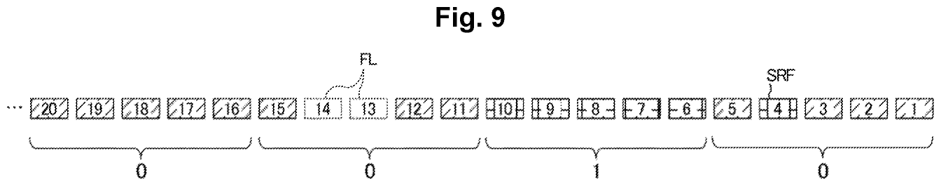

FIG. 9 is a schematic diagram for explaining operation of a communications system according to the fourth embodiment of the present invention.

During transmission on redundant routes, it is conceivable that there may be cases in which frame order reversal or frame losses will occur due to a transmission delay caused by congestion. An out-of-order frame SRF subjected to frame order reversal is a frame that arrives first at the second relay port RP2 even though originally it should have arrived first at the first relay port RP1 as with, for example, the user data frame assigned a sequence number of 4 shown in FIG. 9. A frame loss FL is a failure to receive a frame that originally should have been received as with, for example, the user data frame indicated by a dotted rectangle in FIG. 9.

If such an out-of-order frame SRF or frame loss FL occurs, the original sub-signal SS may not be able to be reproduced from a decoded signal. Thus, according to the present embodiment, one bit of the sub-signal SS is expressed by multiple frames such as five frames of main signals MS as shown in FIG. 9 rather than by one frame of a main signal MS as with the first to third embodiments.

In this way, if a signal pattern of the sub-signal SS desired to be transmitted is transmitted redundantly using a predetermined number of first-arriving main signals MS and one value of the sub-signal SS is decoded on the receiving end according to a combination of route determination results on the predetermined number of first-arriving main signals MS, it is possible to implement robust transmission capable of correcting information losses during transmission.

### Fifth Embodiment

Whereas a single sub-signal channel is provided in the first to fourth embodiments described above, it is also possible to multiplex sub-signal channels and transmit main signals and plural sub-signals.

(Configuration)

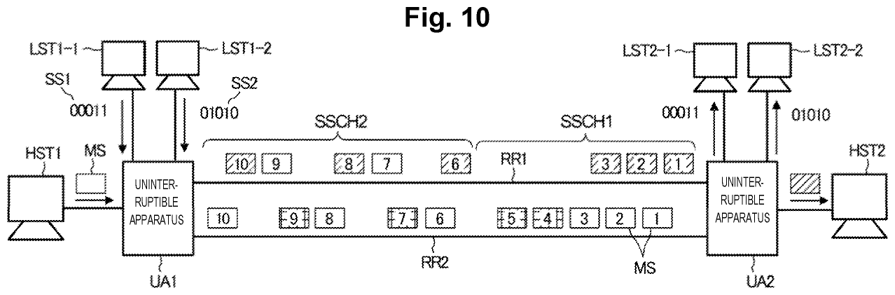

FIG. 10 is a schematic diagram showing an exemplary schematic configuration, and explaining operation, of a communications system according to a fifth embodiment of the present invention. According to the present embodiment, the first uninterruptible apparatus UA1 serving as a transmission apparatus is connected with a first high-speed user terminal HST1 configured to accept input of main signals MS to be transmitted to the first uninterruptible apparatus UA1 through a main signal channel, with a primary first low-speed user terminal LST1-1 configured to accept input of a first sub-signal SS1 to be transmitted through a sub-signal channel, and with a secondary first low-speed user terminal LST1-2 configured to accept input of a second sub-signal SS1 to be transmitted through the sub-signal channel. That is, two first user terminals +ST1 are connected to the first uninterruptible apparatus UA1. The second uninterruptible apparatus UA2 serving as a reception apparatus is connected with a second high-speed user terminal HST2 configured to accept input of main signals MS received from the second uninterruptible apparatus UA2, with a primary second low-speed user terminal LST2-1 configured to accept input of a received first sub-signal SS1, and with a secondary second low-speed user terminal LST2-2 configured to accept input of a received second sub-signal SS2. That is, two second low-speed user terminals LST2 are connected to the second uninterruptible apparatus UA2.

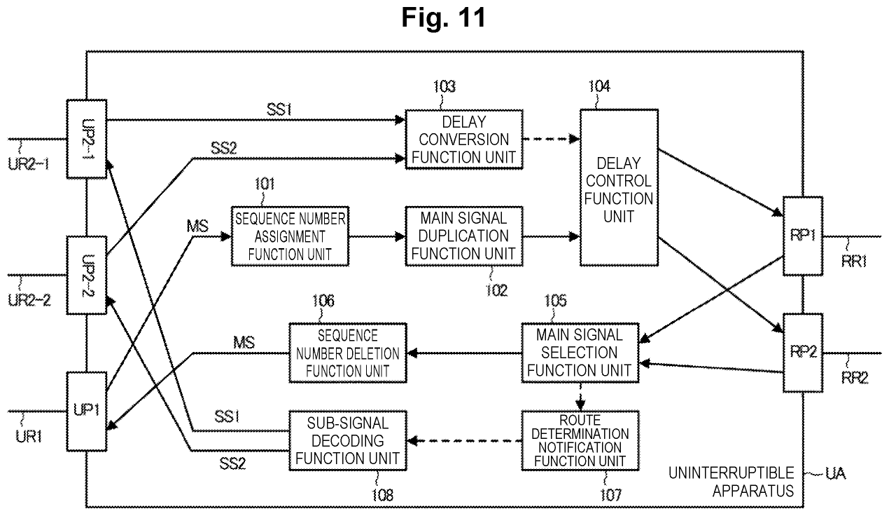

FIG. 11 is a block diagram showing an exemplary configuration of an uninterruptible apparatus UA in the communications system according to the fifth embodiment. As shown in FIG. 11, compared to the configuration of the uninterruptible apparatus UA according to the first embodiment, the uninterruptible apparatus UA according to the present embodiment includes two second user ports UP2, i.e., a primary second user port UP2-1 and a secondary second user port UP2-2. The primary second user port UP2-1 is used to receive the first sub-signal SS1 inputted from the primary first low-speed user terminal LST1-1 on the sending end via a primary second user route UR2-1 and transmit the first sub-signal SS1 to be outputted to the primary second low-speed user terminal LST2-1 on the receiving end via a primary second user route UR2-1. The secondary second user port UP2-2 is used to receive the second sub-signal SS2 inputted from the secondary first low-speed user terminal LST1-2 on the sending end via a secondary second user route UR2-2 and transmit the second sub-signal SS2 to be outputted to the secondary second low-speed user terminal LST2-2 on the receiving end via the secondary second user route UR2-2.

As described above in the first embodiment, the delay conversion function unit 103 converts the first sub-signal SS1 received at the primary second user port UP2-1 into a delay and converts the second sub-signal SS2 received at the secondary second user port UP2-2 into a delay.

As described above in the first embodiment, the delay control function unit 104 sends out the two copies of the main signal MS assigned the sequence number, to the two relay ports RP, the two copies having been supplied from the main signal duplication function unit 102, and thereby transmits the two copies of the main signal MS to the uninterruptible apparatus UA on the receiving end via redundant routes, i.e., the two relay routes RR. In sending out the two copies of the main signal MS assigned the sequence number, to the two relay ports RP, the delay control function unit 104 controls the sending timings of the two copies of the main signal MS based on either one of two delay conversion results supplied from the delay conversion function unit 103. That is, the delay control function unit 104 sends out the two copies of the main signal MS to the two relay ports RP by alternately switching between sending timing control over the main signal MS based on one of the two delay conversion results and sending timing control over the main signal MS based on the other of the two delay conversion results. The switching may be done according to the frame count of the main signals MS or according to time.

As described above in the first embodiment, the sub-signal decoding function unit 108 decodes the sub-signal SS transmitted through the sub-signal channel, based on the determination result sent from the route determination notification function unit 107. Then, the sub-signal decoding function unit 108 sends out the decoding results to user ports and thereby transmits the decoding results to the low-speed user terminals on the receiving end according to the frame count of the main signals MS or according to time, as described below. That is, in the case of the first sub-signal SS1, the sub-signal decoding function unit 108 sends out the decoding result to the primary second user port UP2-1 and thereby transmits the decoding result to the primary second low-speed user terminal LST2-1 on the receiving end via the primary second user route UR2-1. In the case of the second sub-signal SS2, the sub-signal decoding function unit 108 sends out the decoding result to the secondary second user port UP2-2 and thereby transmits the decoding result to the secondary second low-speed user terminal LST2-2 on the receiving end via the secondary second user route UR2-2.

(Operation)

According to the fifth embodiment, as shown in FIG. 10, the first uninterruptible apparatus UA1 on the sending end transmits the main signals MS on the two relay routes RR by alternately switching between a first sub-signal channel SSCH1 and a second sub-signal channel SSCH2. The sending timings of the main signals MS on the first sub-signal channel SSCH1 have been adjusted based on the delay conversion results on the first sub-signal SS1. Also, the sending timings of the main signals MS on the second sub-signal channel SSCH2 have been adjusted based on the delay conversion results on the second sub-signal SS2. FIG. 10 shows an example of switching sub-signal channels every five frames of main signals MS. In this example, on the first sub-signal channel SSCH1, the frames of main signals MS arrive first at the second uninterruptible apparatus UA2 on the receiving end through routes arranged in the following order: the first relay route RR1 (relay port RP1), the first relay route RR1 (relay port RP1), the first relay route RR1 (relay port RP1), the second relay route RR2 (relay port RP2), and the second relay route RR2 (relay port RP2). Thus, based on the relay ports RP at which the main signals MS have arrived first, the sub-signal decoding function unit 108 of the second uninterruptible apparatus UA2 decodes a data signal of “00011” and transmits the decoded signal from the first user port UP1 to the primary second low-speed user terminal LST2-1. In this way, the sub-signal SS1 can be transmitted from the primary first low-speed user terminal LST1-1 to the primary second low-speed user terminal LST2-1. On the second sub-signal channel SSCH1, frames arrive first at the second uninterruptible apparatus UA2 through routes arranged in the following order: the first relay route RR1 (relay port RP1), the second relay route RR2 (relay port RP2), the first relay route RR1 (relay port RP1), the second relay route RR2 (relay port RP2), and the first relay route RR1 (relay port RP1). Thus, the data signal “01010” of the second sub-signal SS2 can be transmitted from the secondary first low-speed user terminal LST1-2 to the secondary second low-speed user terminal LST2-2.

In this way, by adopting a time-division multiplexing scheme, the first sub-signal SS and the second sub-signal SS2 can be transmitted by switching sub-signal channels in time series according to frame count (or time).

Note that a large number of sub-signals SS can be transmitted by increasing the number of time divisions and providing a large number of sub-signal channels. However, when the number of sub-signal channels (sub-signals SS) is n (where n is an integer larger than 1), the bit rate becomes 1/n that of the first embodiment.

### Sixth Embodiment

The sixth embodiment is also an example of transmitting main signals and plural sub-signals by multiplex sub-signal channels.

(Configuration)

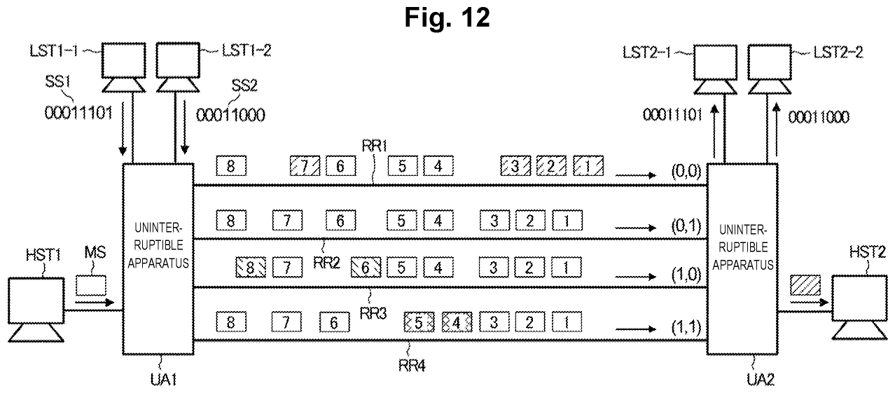

FIG. 12 is a schematic diagram showing an exemplary schematic configuration, and explaining operation, of a communications system according to the sixth embodiment of the present invention. According to the present embodiment, when 2^{m} or more relay routes RR are used to provide redundancy, m sub-signal channels (sub-signals SS) are multiplexed (where m is an integer larger than 0) by allocating m bits to each route. That is, when there are two relay routes RR, one sub-signal channel (sub-signal SS) is made available by allocating 1 bit; when there are four relay routes RR, two sub-signal channels (sub-signals SS) are made available by allocating 2 bits; when there are eight relay routes RR, three sub-signal channels (sub-signals SS) are made available by allocating 3 bits; and so on. FIG. 12 shows an example in which m=2, four relay routes RR1, RR2, RR3, and RR4 are provided, and two sub-signal channels (two sub-signals SS1 and SS 2) are multiplexed.

FIG. 12 is a block diagram showing an exemplary configuration of an uninterruptible apparatus UA in the communications system according to the sixth embodiment. As shown in the figure, as with the fifth embodiment, the uninterruptible apparatus UA according to the present embodiment includes two second user ports UP2, i.e., a primary second user port UP2-1 and a secondary second user port UP2-2. The primary second user port UP2-1 is connected to the primary first low-speed user terminal LST1-1 on the sending end or to the primary second low-speed user terminal LST2-1 on the receiving end via the primary second user route UR2-1. The secondary second user port UP2-2 is connected to the secondary first low-speed user terminal LST1-2 on the sending end or to the secondary second low-speed user terminal LST2-2 on the receiving end via the secondary second user route UR2-2.

Compared to the configuration of the uninterruptible apparatus UA according to the first embodiment, the uninterruptible apparatus UA according to the present embodiment includes four relay ports RP, i.e., a first relay port RP1, a second relay port RP2, a third relay port RP3, and a fourth relay port RP4.

The main signal duplication function unit 102 duplicates the main signal MS assigned a sequence number supplied from the sequence number assignment function unit 101, according to the number of redundant routes, i.e., according to the number of relay ports possessed by the uninterruptible apparatus UA. According to the present embodiment, since the uninterruptible apparatus UA has four relay ports RP, the main signal duplication function unit 102 creates three duplicates of the main signal MS assigned a sequence number by the sequence number assignment function unit 101, and thereby obtains four copies of the main signal MS. The main signal duplication function unit 102 supplies the delay control function unit 104 with the four copies of the main signal MS assigned the sequence number.

Based on a combination of the first sub-signal SS1 received at the primary second user port UP2-1 and the second sub-signal SS2 received at the secondary second user port UP2-2, the delay conversion function unit 103 converts the first and second sub-signals SS1 and SS2 into delays. For example, if the first and second sub-signals SS1 and SS2 are user data signals that are code sequences made up of 0s and 1s, based on combinations of the 0s and 1s, which are values of bits in the user data signals, the delay conversion function unit 103 can determine how much delay to be given to which of the main signals MS to be sent out from the first to fourth relay ports RP1 to RP4. In other words, if a combination of bit values of the first and second sub-signals SS1 and SS2 is expressed as “(bit value of the first sub-signal SS1, bit value of the second sub-signal SS2),” the delay conversion function unit 103 determines the delay amount at each relay port RP based on which of (0, 0), (0, 1), (1, 0), and (1, 1) the combination is. Here, the combination of (0, 0) is allocated to the first relay port RP1, i.e., the first relay route RR1. Similarly, (0, 1) is allocated to the second relay port RP2 (second relay route RR2), (1, 0) is allocated to the third relay port RP3 (third relay route RR3), and (1, 1) is allocated to fourth relay port RP4 (fourth relay route RR4).

The delay control function unit 104 sends out the four copies of the main signal MS assigned the sequence number, to the four relay ports RP, the four copies having been supplied from the main signal duplication function unit 102, and thereby transmits the four copies of the main signal MS to the uninterruptible apparatus UA on the receiving end via redundant routes, i.e., the four relay routes RR. In sending out the four copies of the main signal MS assigned the sequence number, to the four relay ports RP, the delay control function unit 104 controls the sending timings of the four copies of the main signal MS based on delay conversion results supplied from the delay conversion function unit 103.

The sub-signal decoding function unit 108 decodes the first and second sub-signals SS1 and SS2 transmitted through the sub-signal channels, based on the determination result sent from the route determination notification function unit 107 and sends out the respective decoding results to the primary second user port UP2-1 and the secondary second user port UP2-2. Consequently, the sub-signal decoding function unit 108 transmits the decoding results to the primary second low-speed user terminal LST2-1 and secondary second low-speed user terminal LST2-2 on the receiving end via the primary second user route UR2-1 and the secondary second user route UR2-2, respectively.

(Operation)

According to the sixth embodiment, as shown in FIG. 12, delays of the main signals MS transmitted through the first to fourth relay routes RR1 to RR4 are determined based on which of (0, 0), (0, 1), (1, 0), and (1, 1) the combination of bit values of the first and second sub-signals SS1 and SS2 is. Suppose, for example, that data values of the first sub-signal SS1 and second sub-signal SS2 are “00011101” and “00011000” as shown in FIG. 12. In this case, since the respective MSBs of the data values are “0” and “0,” the combination thereof is (0, 0), and thus the first relay route RR1 (first relay port RP1) transmits data without a delay and the second to fourth relay routes RR2 to RR4 (second to fourth relay ports RP2 to RP4) transmit data with delays. Similarly, if the combination of bit values is (0, 1), the second relay route RR2 (second relay port RP2) transmits data without a delay and the first, third, and fourth relay routes RR1, RR3, and RR4 (first, third, and fourth relay ports RP1, RP3, and RP4) transmit data with delays. Similarly, if the combination of bit values is (1, 0), the third relay route RR3 (third relay port RP3) transmits data without a delay and the first, second, and fourth relay routes RR1, RR2, and RR4, (first, second, and fourth relay ports RP1, RP2, and RP4) transmit data with delays. If the combination of bit values is (1, 1), the fourth relay route RR4 (fourth relay port RP4) transmits data without a delay and the first to third relay routes RR1 to RR3 (first to third relay ports RP1 to RP3) transmit data with delays.

The second uninterruptible apparatus UA2 on the receiving end decodes the bit value of the first sub-signal SS1 and the bit value of the second sub-signal SS2 based on which relay route RR the first-arriving frame of the main signal MS has traveled along and which relay port RP has received the first-arriving frame. In the example of FIG. 12, the first-arriving frames have come by way of: the first relay port RP1, the first relay port RP1, the first relay port RP1, the fourth relay port RP4, the fourth relay port RP4, the third relay port RP3, the first relay port RP1, and the third relay port RP3. Thus, the combinations of bit values of the first sub-signal SS1 and bit values of the second sub-signal SS2 are (0, 0), (0, 0), (0, 0), (1, 1), (1, 1), (1, 0), (0, 0), and (1, 0). Consequently, a data signal of a bit sequence “00011101” is transmitted from the primary second user port UP2-1 to the primary second low-speed user terminal LST2-1 via the primary second route UR2-1. Also, a data signal of a bit sequence “00011000” is transmitted from the secondary second user port UP2-2 to the secondary second low-speed user terminal LST2-2 via the secondary second route UR2-2.

In this way, when 2^{m} or more relay routes RR are used to provide redundancy, m bits are allocated to each route. Consequently, according to the sixth embodiment, single bits of m sub-signal channels (sub-signals SS) transmitted by one frame of a main signal MS, which are information equal in amount to m bits, are multiplexed m-fold, i.e., one bit each of m sub-signals can be transmitted together by one frame of a main signal MS using m-fold multiplexing. However, the bit rate depends on the value of m, i.e., the bit rate becomes 1/m that of the first embodiment.

Although four-route redundancy (m=2) is applied to the relay routes RR and two sub-signal channels are multiplexed by allocating 2 bits (0, 0; 0, 1; 1, 0; or 1, 1) in the examples shown in FIGS. 10 and 11, various types of multiplexing are available depending on the value of m. For example, if two-route redundancy (m=1) is applied to the relay routes RR, one sub-signal channel can be multiplexed by allocating 1 bit (0/1); and if eight-route redundancy (m=3) is applied to the relay routes RR, three sub-signal channels can be multiplexed by allocating 3 bits (0, 0, 0; 0, 0, 1; 0, 1, 0; 0, 1, 1; 1, 0, 0; 1, 0, 1; 1, 1, 0; or 1, 1, 1). Here, the values of 3 bits are expressed as “(bit value of the first sub-signal SS1, bit value of the second sub-signal SS2, and bit value of the third sub-signal SS3).”

Note that by combining the technique of the sixth embodiment with the technique of the fifth embodiment, many more sub-signal channels can be multiplexed.

### Other Embodiments

Although, in the above embodiments, the sub-signal channels have been described as being intended for low-speed communications, the present invention is not limited to low-speed communications or data signal communications, and needless to say, is applicable to user frame communications.

The techniques described in the above embodiments can be distributed as programs (software means) executable by a computer by being stored in a recording medium or by being transmitted via a communications medium, where examples of the recording medium include magnetic disks (a floppy (registered trademark) disk, a hard disk, and the like), optical disks (a CD-ROM, a DVD, an MO, and the like), semiconductor memories (a ROM, a RAM, a flash memory, and the like). Note that the programs stored in the medium also include a configuration program that configures, in the computer, software means (including not only executable programs, but also tables and data structures) to be executed by the computer. The computer that implements the present apparatus performs the above processes by reading the programs recorded on the recording medium, by building software means in some cases using the configuration program, and by allowing the software means to control operation. Note that the recording medium referred to herein is not limited to distribution media, and includes storage media such as magnetic disks and semiconductor memories provided in the computer or devices connected via a network.

In short, the present invention is not limited to the above embodiments, and may be modified in various forms in the implementation stage without departing from the gist of the invention. Also, the embodiments may be implemented in combination as appropriate whenever possible, offering combined effects. Furthermore, the above embodiments include inventions in various stages, and various inventions can be extracted through appropriate combinations of the disclosed components.

### REFERENCE SIGNS LIST

11 Processor

12 Program memory

13 Data memory

14 Input/output interface

15 Communications interface

16 Bus

101 Sequence number assignment function unit

102 Main signal duplication function unit

103 Delay conversion function unit

104 Delay control function unit

105 Main signal selection function unit

106 Sequence number deletion function unit

107 Route determination notification function unit

108 Sub-signal decoding function unit

110 Control function unit

120 Signal determination function unit

HST High-speed user terminal

HST1 First high-speed user terminal

HST2 Second high-speed user terminal

LST Low-speed user terminal

LST1 First low-speed user terminal

LST2 Second low-speed user terminal

NW Relay network

NW1 First relay network

NW2 Second relay network

RP Relay port

RP1 First relay port

RP2 Second relay port

RP3 Third relay port

RP4 Fourth relay port

RR Relay route

RR1 First relay route

RR2 Second relay route

RR3 Third relay route

RR4 Fourth relay route

UA Uninterruptible apparatus

UA1 First uninterruptible apparatus

UA2 Second uninterruptible apparatus

UP User port

UP1 First user port

UP2 Second user port

UP2-1 Primary second user port

UP2-2 Secondary second user port

UR User route

UR1 First user route

UR2 Second route

UR2-1 Primary second user route

UR2-2 Secondary second user route

1. A communications system that conducts multiplex communications of main signals and at least one sub-signal via redundant routes between a transmission apparatus and a reception apparatus, wherein:
the transmission apparatus includes:
a main signal duplication unit configured to duplicate each of the main signals to be communicated via a main signal channel, according to the number of the redundant routes, and
a delay unit configured to adjust sending timings of copies of the main signal on the respective redundant routes based on the at least one sub-signal to be communicated via a sub-signal channel and transmit the copies of the main signal to the respective redundant routes; and
the reception apparatus includes:
a main signal selection unit configured to select one of the copies of the main signal communicated via the main signal channel, according to reception timings of the copies of the main signal passing through the respective redundant routes, and
a sub-signal decoding unit configured to decode the at least one sub-signal communicated via the at least one sub-signal channel based on which of the redundant routes the selected copy of the main signal has passed.

2. The communications system according to claim 1, wherein:
the main signal duplication unit of the transmission apparatus includes:
a sequence number assignment unit configured to assign the main signals respective sequence numbers used to identify an order of the signals, and
a duplication unit configured to duplicate each of the main signals assigned the sequence numbers, according to the number of the redundant routes;
the delay unit of the transmission apparatus includes:
a delay conversion unit configured to convert the at least one sub-signal into a delay, and
a delay control unit configured to control sending timings of the copies of the main signal to the respective redundant routes based on the delay;
the main signal selection unit of the reception apparatus includes:
a selection unit configured to distinguish and select a first-arriving main signal, which is that copy of the main signal which arrives first at the reception apparatus, based on the sequence numbers assigned to the main signals passing through the redundant routes, and
a sequence number deletion unit configured to delete the sequence number assigned to the main signal from the first-arriving main signal selected by the selection unit; and
the sub-signal decoding unit of the reception apparatus includes:
a route determination unit configured to determine which of the redundant routes the first-arriving main signal selected by the selection unit has passed, and
a decoding unit configured to decode the at least one sub-signal based on determination results produced by the route determination unit.

3. The communications system according to claim 2, wherein:
the transmission apparatus further includes:
a port to which the main signal to be transmitted is inputted, and
at least one port to which the at least one sub-signal to be transmitted is inputted;
the reception apparatus further includes:
a port from which the main signal with the sequence number deleted therefrom is outputted, and
at least one port from which the at least one decoded sub-signal is outputted.

4. The communications system according to claim 3, wherein:
the at least one port of the transmission apparatus, the at least one sub-signal being inputted to the at least one port, includes n ports to which n sub-signals are inputted (where n is an integer larger than 1);
to control timings for sending the copies of the main signal to the respective redundant routes, the delay control unit of the transmission apparatus uses delays converted from respective ones of the n sub-signals, by switching the delays in time series;
the decoding unit of the reception apparatus decodes the n sub-signals by switching, in time series, decoding of the n sub-signals based on the determination results produced by the route determination unit; and
the at least one port of the reception apparatus, the at least one decoded sub-signal being outputted from the at least one port, includes n ports from which the n sub-signals are outputted.

5. The communications system according to claim 3, wherein:
the number of the redundant routes is 2^{m} (where m is an integer larger than 0);
the at least one port of the transmission apparatus, the at least one sub-signal being inputted to the at least one port, includes m ports to which m sub-signals are inputted;
the delay control unit of the transmission apparatus controls sending timings of the copies of the main signal to the m redundant routes by allocating m bits to each of the redundant routes such that one bit each of the m sub-signals are transmitted by one frame of the main signal using m-fold multiplexing;
the decoding unit of the reception apparatus decodes one bit each of the m sub-signals based on the determination results produced by the route determination unit; and
the at least one port of the reception apparatus, the at least one decoded sub-signal being outputted from the at least one port, includes m ports from which respective single bits of the m sub-signals are outputted.

6. The communications system according to claim 2, wherein:
the transmission apparatus further includes:
a port to which the main signal to be transmitted is inputted, and
a sub-signal generation unit configured to generate the at least one sub-signal to be transmitted; and
the reception apparatus includes:
a port from which the main signal with the sequence number deleted therefrom is outputted, and
a sub-signal utilizing unit configured to perform operation based on the at least one decoded sub-signal.

7. The communications system according to claim 2, wherein:
the transmission apparatus further includes:
a port to which an input signal including the main signal and the at least one sub-signal to be transmitted is inputted, and
a separation unit configured to separate the main signal and the at least one sub-signal from the input signal; and
the reception apparatus includes at least one port from which the main signal with the sequence number deleted therefrom and the at least one decoded sub-signal are outputted.

8. The communications system according to claim 2, wherein the decoding unit decodes one value of the at least one sub-signal based on a combination of the determination results on a predetermined number of first-arriving main signals, the determination results being produced by the route determination unit.

9. A transmission apparatus in a communications system that conducts multiplex communications of main signals and at least one sub-signal via redundant routes between the transmission apparatus and a reception apparatus, the transmission apparatus comprising:
a main signal duplication unit configured to duplicate each of the main signals to be communicated via a main signal channel, according to the number of the redundant routes; and
a delay unit configured to adjust sending timings of copies of the main signal on the respective redundant routes based on the at least one sub-signal to be communicated via a sub-signal channel and transmit the copies of the main signal to the respective redundant routes.

10. (canceled)

11. A communications method for a communications system that conducts multiplex communications of main signals and at least one sub-signal via redundant routes between a transmission apparatus and a reception apparatus, the method comprising:
by the transmission apparatus, duplicating each of the main signals to be communicated via a main signal channel, according to the number of the redundant routes;
by the transmission apparatus, adjusting sending timings of copies of the main signal on the respective redundant routes based on the at least one sub-signal to be communicated via a sub-signal channel and transmitting the copies of the main signal to the respective redundant routes;
by the reception apparatus, selecting one of the copies of the main signal communicated via the main signal channel, according to reception timings of the copies of the main signal passing through the respective redundant routes; and
by the reception apparatus, decoding the at least one sub-signal communicated via the sub-signal channel based on which of the redundant routes the selected copy of the main signal has passed.

12. A non-transitory computer-readable medium having computer-executable instructions that, upon execution of the instructions by a processor of a computer, cause the computer to function as the transmission apparatus according to claim 1.
